(19) United States
(12) Patent Application Publication
(10) Pub. No.: US 2015/0176433 A1
(43) Pub. Date: Jun. 25, 2015

(54) TURBINE HOUSING FOR AN EXHAUST GAS TURBOCHARGER

(71) Applicant: Bosch Mahle Turbo Systems GmbH & Co. KG, Stuttgart (DE)

(72) Inventors: Martin Schlegl, Rudersberg (DE); Timo Tries, Weissach/Flacht (DE)

(21) Appl. No.: 14/575,668

(22) Filed: Dec. 18, 2014

(30) Foreign Application Priority Data
Dec. 19, 2013 (DE) 102013226665.0
May 21, 2014 (DE) 102014209666.9

(51) Int. Cl. F01D 25/24; F01D 17/10

(52) U.S. Cl. CPC F01D 25/24; F01D 17/105; F05D 2250/15; F05D 2230/232; F05D 2230/238; F05D 2220/40

(57) ABSTRACT

A turbine housing for an exhaust gas turbocharger may include a wastegate valve that may have at least two apertures. A first aperture may be configured to receive a wastegate shaft and a second aperture may be configured as an inlet to a bypass channel. An insert may include a valve seat for the wastegate valve and a bearing bush for mounting the wastegate shaft. The valve seat may be mounted by a matching valve disc. The valve seat may cover the second aperture and the bearing bush may cover the first aperture in an installed state of the insert.

### CROSS REFERENCE TO RELATED APPLICATIONS

This application claims priority to German Patent Application No. 10 2013 226 665.0 filed Dec. 19, 2013, and German Patent Application No. 10 2014 209 666.9, filed May 21, 2014, the contents of which are hereby incorporated by reference in their entirety.

### TECHNICAL FIELD

The present invention relates to a turbine housing for an exhaust gas turbocharger with a wastegate valve according to the preamble of claim 1. The invention additionally relates to an exhaust gas turbocharger with such a turbine housing and to an insert for such a turbine housing.

Usually, cast or cast steel turbine housings are employed with exhaust gas turbochargers. A modification in this regard is offered for example by turbine housings made of sheet metal, which are characterized by a reduced wall thickness compared to the production-based (minimum) wall thicknesses of the cast turbine housing. Usually, modern exhaust gas turbochargers comprise a so-called wastegate valve, by means of which a turbine of the exhaust gas turbocharger is bypassed and by means of which the performance of the same is to be influenced. Such a wastegate valve usually consists of a valve disc, which by means of a wastegate shaft is guided through the turbine housing and a valve seat, which is arranged on the turbine housing. In order to be able to mount the wastegate shaft on the turbine housing a bearing bush is provided in particular in the case of sheet metal turbine housings, the connection of which however can lead to problems because of the comparatively small wall thicknesses in the case of a sheet metal turbine housing. In the case of a cast or cast steel turbine housing, thickening by contrast can be realised significantly more easily. When employing a bearing bush for mounting or passing through the wastegate shaft attention has to be paid in particular that no deformations result through extreme forces, for example through the exhaust gas flow or through the actuator for adjusting the wastegate shaft that can lead to unintentional leakage during the operation of the exhaust gas turbocharger. For this reason, the bearing bush is often clamped, welded, soldered or otherwise connected to a sheet metal turbine housing in a gas-tight manner. However, positioning of the bearing bush can prove difficult here since orientation regarding the valve seat of the wastegate valve is only possible with difficulty because of the relatively small sheet metal thickness of the sheet metal turbine housing.

### BACKGROUND

From DE 10 2004 039 477 A1 a generic turbine housing for an exhaust gas turbocharger is known, which comprises a single-flow volute housing produced from sheet metal. This volute housing is assembled from a first and a second part, wherein the two parts are connected to one another at a radially outer region of the volute housing. The second part of the volute housing merges from the radially outer region into a radially middle region and into a radially inner region, while on its radially inner region it is connected to an outlet pipe.

From EP 1 287 235 B1 a housing arrangement for a turbine of an exhaust gas turbocharger with a volute housing is known. The housing arrangement comprises a strap-like wall part in the interior of the volute housing, an inlet connection, an outlet connection and a flange for connecting the volute housing to a bearing housing. The outlet connection in this case has a bulge which covers the strap region of the volute housing.

The present invention deals with the problem of stating an improved or at least an alternative embodiment for a turbine housing of the generic type, which is to improve in particular a connection of a bearing bush and its orientation regarding a valve seat of a wastegate valve, in particular in the case of a sheet metal turbine housing.

According to the invention, this problem is solved through the subject of the independent claim 1. Advantageous embodiments are subject of the dependent claims.

### SUMMARY

The present invention is based on the general idea of providing an insert in the use of comparatively light turbine housings in particular produced from sheet metal, which insert at the same time makes available a valve seat for a wastegate valve and a bearing bush for mounting a wastegate shaft, thereby rendering obsolete the orientation of these two elements relative to one another, which has been difficult in the past in the case of sheet metal turbine housings. The great advantage of the insert according to the invention thus is that the same connects in one part or one piece both the valve seat as well as the associated bearing bush, so that these can be installed in the turbine housing already pre-aligned with the insert. Here, the insert is designed in such a manner that in the installed state its valve seat covers the one aperture and the bearing bush the other aperture in the turbine housing, so that following installation of the insert in the turbine housing, the assembly of the wastegate shaft can commence immediately, on the end of which shaft a valve disc fitting the valve seat is arranged. The previously elaborate alignment of the bearing bush relative to the valve seat that was necessary in the past can be omitted since these two components can be fixed in the insert already pre-aligned and installed in the turbine housing in this way. By combining the valve seat and the bearing bush in the insert, high-quality processing of the same in a separate location is also possible and need not only be accomplished when assembling the turbine housing. In addition to this, tilting of the bearing bush through the only relatively small connection in the sheet metal housing (and thus possible leakage) can be reduced to a minimum. Through the insert, the contact areas to the sheet metal turbine housing can be additionally increased, as a result of which stress peaks can be reduced in particular. Obviously the insert can also be employed with turbine housings of cast aluminium.

In an advantageous further development of the solution according to the invention the insert is designed as a shaped sheet metal part. Producing such an insert designed as a shaped sheet metal part is thus possible in high quality and on the one hand and cost-effectively on the other hand, which brings substantial advantages with respect to production and production costs.

In a further advantageous embodiment of the solution according to the invention, the insert is tightly connected to the turbine housing, in particular via screws, soldered, welded or glued. The insert in this case provides a significantly larger contact area to the turbine housing, as a result of which a tight connection even in the long term can be ensured by reducing stress peaks.

Practically, the insert is designed as a shaped sheet metal angle and on its first leg carries the valve seat and on its second leg the bearing bush. Here, the bearing bush and the valve seat respectively can be optionally formed in one piece with the insert or designed as a separate component and only later on connected to the insert, in particular soldered, crimped, welded or screwed. Independently of the selected embodiment of the insert or the one-part or one-piece embodiment, prefabrication and thus pre-alignment of the bearing bush relative to the valve seat can also take place here, as a result of which this comparatively elaborate adjusting operation during the assembly of the turbine housing and thus also during the assembly of the exhaust gas turbocharger can be omitted. If the bearing bush and the valve seat for example are formed in one piece with the insert it is conceivable that these can be formed out of the shaped sheet metal part through suitable forming operations. Obviously it is also conceivable here that such a valve seat or such a bearing bush is still re-worked or finished in a second production step.

In a further advantageous embodiment of the solution according to the invention, the bearing bush on its outside comprises an external thread via which the insert can be screwed to the turbine housing by means of a nut. Between the nut and the turbine housing which is formed in particular from sheet metal a gasket is advantageously inserted in this case which makes possible a gas-tight connection of the insert to the turbine housing. Such an insert fastened to the turbine housing additionally offers the possibility of easy disassembly, as a result of which in particular the maintenance friendliness of the exhaust gas turbocharger according to the invention and of the turbine housing according to the invention can be increased.

Further important features and advantages of the invention are obtained from the subclaims, from the drawings and from the associated figure description with the help of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference numbers relate to same or similar or functionally same components.

### BRIEF DESCRIPTION OF THE DRAWINGS

It shows, in each case schematically

FIG. 1 a sectional representation through a turbine housing according to the invention in the region of an insert according to the invention.

FIG. 2 a representation as in FIG. 1, however in another embodiment,

FIG. 3 a representation as in FIG. 1, however with an insert screwed to the turbine housing,

FIG. 4 a detail view of a possible embodiment of the insert according to the invention,

FIG. 5 a representation as in FIG. 4, however with wastegate shaft and valve disc.

### DETAILED DESCRIPTION

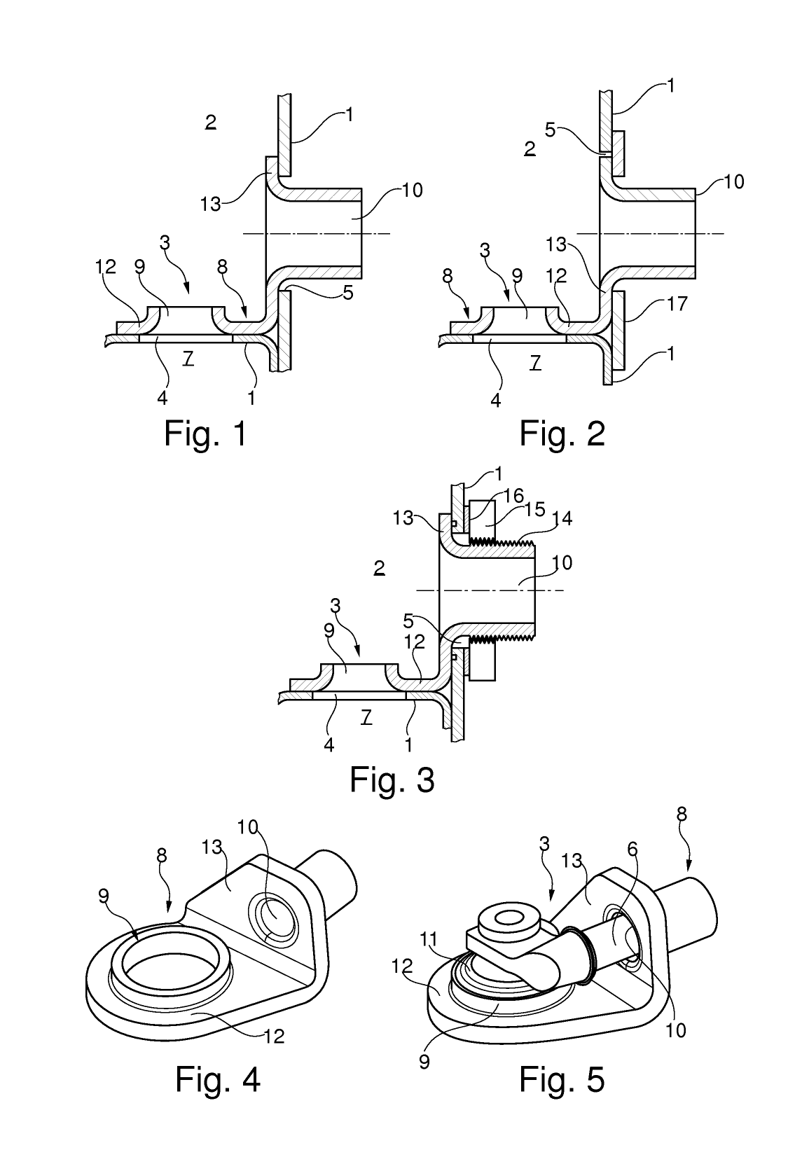

According to the FIGS. 1 to 3, a turbine housing 1 according to the invention for an exhaust gas turbocharger 2 comprises a wastegate valve 3 (see FIG. 5) and two apertures 4 and 5, of which the one aperture 5 is designed for passing through a bearing bush of a wastegate shaft 6 of an insert 8 according to the invention (again see FIG. 5) and the other aperture 4 as an inlet to a bypass channel 7. According to the invention, an insert 8 (see FIGS. 1 to 5) is now provided, which comprises a valve seat 9 for the wastegate valve 3 and a bearing bush 10 for mounting the wastegate shaft 6, wherein on the end of the wastegate shaft 6 a valve disc 11 (see FIG. 5) matching the valve seat 9 is arranged. With the valve disc 11, the valve seat 9 can be tightly covered and the wastegate valve 3 thereby closed. Additionally, the insert 8 according to the invention is designed in such a manner that in the installed state its valve seat 9 covers the one aperture 4 and the bearing bush 10 engages through the other aperture 5. With the insert 8 according to the invention, which within itself receives both the valve seat 9 and also the bearing bush 10, difficult alignment of a separate bearing bush which is used during the assembly of the exhaust gas turbocharger 2 into the turbine housing 1 in particular is obsolete since the pre-alignment of the bearing bush 10 relative to the valve seat 9 already takes place during the separate production of the insert 8.

The turbine housing 1 in this case is preferentially formed or assembled from sheet metal, in particular even of multiple sheet metal parts, wherein obviously an embodiment as a casting is also conceivable.

The insert 8 itself is formed as a sheet metal part and tightly connected to the turbine housing 1, in particular screwed (see FIG. 3), soldered, welded or glued. Generally, the insert 8 is designed as a shaped sheet metal angle in the shown figures and carries the valve seat 9 on its first leg 12 and the bearing bush 10 on its second leg 13. Here, both the bearing bush 10 and also the valve seat 9 are unitarily formed with the insert 8 in the shown figures, but can be alternatively also finished for example in a reworking step following the production of the insert 8 for example. Alternatively it is also conceivable that the bearing bush 10 and/or the valve seat 9 are/is formed as separate components (no sheet metal parts) and subsequently connected to the insert 8, in particular soldered, crimped, screwed or welded.

Looking for example at FIG. 3, it can be noticed therein that the bearing bush 10 on its outside comprises an external thread 14, via which it can be screwed to the turbine housing 1 by means of a nut 15. In order to be able to seal the aperture 5 in a gas-tight manner, a gasket 16 is arranged between the nut 15 and the turbine housing 1. The same can obviously be omitted in the case of welding or soldering or gluing.

Preferentially, the insert 8 has a greater wall thickness and/or a higher strength than the sheet metal part of the turbine housing 1, as a result of which optimal alignment of the bearing bush 10 relative to the valve seat 9 and thus reliable closing of the wastegate valve 3 even in the long term can be ensured.

To assemble the insert 8 in the turbine housing 1 there are multiple possibilities in principle. In a first alternative the insert 8 is initially inserted in the turbine housing 1 and inserted with its bearing bush 10 through the associated aperture 5 in the turbine housing 1 towards the outside. Following this, both legs 12, 13 are consecutively or simultaneously connected to the turbine housing 1, for example soldered or welded. Looking at the embodiment according to FIG. 3 a screw connection with corresponding gasket 16 is also conceivable.

An alternative possibility of installing the insert 8 in the turbine housing 1 consists in introducing the insert 8, either with or without inserted wastegate shaft 6, through the aperture 5 in the turbine housing 1. To this end it would be helpful for example to slide an additional (larger) sheet metal element 17 (see FIG. 2) over the aperture 5 and connected in a gas-tight manner since this enlarged contact surface has to completely cover the aperture 5 in the turbine housing 1 and as a side effect can increase the stiffness of the bearing bush 10. Here, the sheet metal element 17 is not only connected to the turbine housing 1 in a gas-tight manner but simultaneously also connected to the insert 8 in a gas-tight manner. The sheet metal element 17 is needed in order to be able to assemble the insert 8 from the outside since the connection geometry between turbine housing 1 and insert 8 would otherwise have a joint stump during welding. It would also be conceivable to insert the insert 8 as an assembly together with the wastegate shaft 6.

In a further alternative embodiment it is conceivable to provide an external thread 14 on the bearing bush 10 and to insert the same with said external thread 14 through the aperture 5 of the turbine housing 1. Following this, the insert 8 is screwed to the turbine housing 1 in a gas-tight manner by turning on the nut 15 subject to inserting the gasket 16 in between.

The present invention thus makes possible a clearly simplified yet highly accurate assembly of a turbine housing 1, in particular in the adjustment-critical region of the bearing bush 10 and of the associated valve seat 9. These components which were separate up to now had to be elaborately aligned relative to one another up to now in order to be able to ensure reliable closing of the wastegate valve 3. By combining the bearing bush 10 and the valve seat 9 in the insert 8, the same can be produced as a prefabricated and also pre-aligned component and installed in the turbine housing 1 in the pre-aligned state, as a result of which the elaborate adjusting operation in its entirety is no longer required.

1.-20. (canceled)

21. A turbine housing for an exhaust gas turbocharger, comprising:
a wastegate valve including at least two apertures, a first aperture configured to receive a wastegate shaft and a second aperture configured as an inlet to a bypass channel;
an insert including a valve seat for the wastegate valve and a bearing bush for mounting the wastegate shaft, wherein the valve seat is mounted by a matching valve disc;
wherein the valve seat covers the second aperture and the bearing bush covers the first aperture in an installed state of the insert.

22. The turbine housing according to claim 21, wherein at least one of the turbine housing is composed of at least two sheet metal parts and the turbine housing is composed of an aluminum casting.

23. The turbine housing according to claim 22, wherein the insert includes at least one of a greater wall thickness and a greater strength than the at least two sheet metal parts.

24. The turbine housing according to claim 21, wherein the insert is configured as a shaped sheet metal part.

25. The turbine housing according to claim 24, wherein the insert is connected to the turbine housing via being at least one of screwed, soldered, welded and adhered.

26. The turbine housing according to claim 21, wherein the insert is configured as a shaped metal angle having a first leg on one end and a second leg on another end, wherein the valve seat is arranged on the first leg and the bearing bush is arranged on the second leg.

27. The turbine housing according to claim 26, wherein at least one of the bearing bush and the valve seat are connected to the insert via being at least one of soldered, crimped and welded.

28. The turbine housing according to claim 26, wherein at least one of the bearing bush and the valve seat are formed in one piece with the insert.

29. The turbine housing according to claim 21, wherein the bearing bush includes an external thread on an outer surface with respect to a valve shaft axis for securing to the turbine housing via a nut.

30. The turbine housing according to claim 21, wherein the insert is at least one of screwed, soldered, welded and adhered to the turbine housing.

31. An exhaust gas turbocharger, comprising:
a turbine housing having a first wall thickness, the turbine housing including a wastegate valve having at least two apertures, a first aperture configured to receive a wastegate shaft and a second aperture configured as an inlet to a bypass channel;
an insert coupled to the turbine housing, wherein the insert defines a shaped angle having a first leg on one end and a second leg on another end; and
a valve seat for the wastegate valve arranged on the first leg and a bearing bush for mounting the wastegate shaft arranged on the second leg, wherein the bearing bush covers the first aperture and the valve seat covers the second aperture, the valve seat including a complementary valve disc mounted thereon;
wherein the insert includes a second wall thickness greater than the first wall thickness of the turbine housing.

32. The exhaust gas turbocharger according to claim 31, wherein the insert is connected to the turbine housing via at least one of screwing, soldering, welding and adhering.

33. The exhaust gas turbocharger according to claim 31, wherein at least one of the valve seat and the bearing bush are formed in one piece with the insert.

34. The exhaust gas turbocharger according to claim 33, wherein at least one of the bearing bush and the valve seat are connected to the insert via at least one of soldered, crimped and welded.

35. The exhaust gas turbocharger according to claim 31, wherein at least one of the bearing bush and the valve seat are connected to the insert via being at least one of soldered, crimped and welded.

36. The exhaust gas turbocharger according to claim 31, wherein the bearing bush includes an external thread that engages a nut to secure the insert to the turbine housing.

37. An insert for a turbine housing, comprising:
a sheet metal component including a valve seat for a wastegate valve and a bearing bush for mounting a wastegate shaft; and
a valve disc mounting the valve seat, the valve disc having a profile matching the valve seat;
wherein the sheet metal component has a wall thickness greater than a wall thickness of the turbine housing.

38. The insert according to claim 37, wherein the sheet metal component defines a shaped angle having a first leg on one end and a second leg on another end, wherein the valve seat is arranged on the first leg and the bearing bush is arranged on the second leg.

39. The insert according to claim 37, wherein at least one of the bearing bush and the valve seat are formed in one piece with the insert.

40. The insert according to claim 37, wherein the bearing bush includes an external thread configured to receive a corresponding nut to attach the sheet metal component to the turbine housing.
